(19) United States
(12) Patent Application Publication
(10) Pub. No.: US 2017/0024783 A1
(43) Pub. Date: Jan. 26, 2017

(54) METHODS AND SYSTEMS FOR RANKING MERCHANTS

(71) Applicant: MasterCard International Incorporated, Purchase, NY (US)

(72) Inventors: Amit Gupta, Dwarka (IN); Ankur Arora, Jasola (IN); Suneel Bhatt, Delhi (IN)

(21) Appl. No.: 15/217,228

(22) Filed: Jul. 22, 2016

(30) Foreign Application Priority Data
Jul. 24, 2015 (SG) 10201505793R

(51) Int. Cl. G06Q 30/02; G06F 17/30

(52) U.S. Cl. CPC G06Q 30/0282; G06F 17/3053; G06F 17/30554; G06Q 50/01

(57) ABSTRACT

A method is proposed for ranking merchants satisfying one or more selected criteria. The merchants are ranked according to an algorithm which calculates a respective score for each merchant as a function of (i) one or more transactional data values characterising previous commercial transactions involving the merchants, (ii) one or more rating values obtained from one of more social media sources and characterising properties of the merchants according to customer feedback, and (iii) pre-determined parameters which control the relative importance of the transactional data values and rating values in determining the scores.

### CROSS-REFERENCE TO RELATED APPLICATION

This application is a U.S. National Stage filing under 35 U.S.C. §119, based on and claiming benefit of and priority to SG Patent Application No. 10201505793R filed Jul. 24, 2015.

### FIELD OF THE INVENTION

The present invention relates to a method and system for forming, and presenting to prospective customers, a ranking between a plurality of merchants who perform commercial transactions.

### BACKGROUND

Frequently a variety of merchants provide goods and/or services (collectively referred to here as “products”) of a specified type, so potential consumers for those goods and services have to choose which merchants to use. Automated systems have been proposed to assist that choice. For example, U.S. Pat. No. 8,725,597 aims to provide an automated mechanism for determining whether any given merchant is a reliable commercial partner, though it does not compare merchants.

Furthermore, various merchant comparison websites exist which present potential customers for products with ranked lists of merchants supplying that product, for example merchants within a given geographical area. For example, the TripAdvisor website allows customers to view a ranked list of hotels or restaurants in a specified a geographical area (e.g. a town). The list may be limited to include only hotels or restaurants which meet certain specified criteria (e.g. hotels which have a particular star rating, or restaurants which serve a particular cuisine).

The rankings are generally based on feedback values entered by members of the public who are previous customers of the merchants (that is, the websites are “social media sources”). However, this is potentially subject to a number of problems which compromise the reliability of the ranking. In particular, it is vulnerable to feedback values being given by individuals who pretend to have used the merchants in question, but in fact have not. Secondly, they may be individuals associated with the merchants, who therefore leaving a feedback value which is biased. Thirdly, even if the individuals are genuine former customers of the merchant, they may be statistically untypical of the merchant's clientele; for example, individuals who have had a bad experience in using the merchant may be more likely to leave a review. These factors result in considerable variability between different ranking websites. For example, FIG. 1 shows real rankings for various restaurants in a certain city, as given by the comparison websites Yelp, Trip Advisor, Just Luxe, Urbanspoon and Zagat. For purposes of anonymity the real names of the restaurants have been replaced by the names “Restaurant A” to “Restaurant Z”, “Restaurant AA” to “Restaurant ZZ” and “Restaurant AAA” to “Restaurant DDD”. Restaurant A, which scores in the top five for four of the merchant comparison websites, is not even in the top 18 according to TripAdvisor.

Because of this, alternative methods of ranking merchants have been considered. For example, U.S. Pat. No. 8,126,779 permits a ranking of merchants in relation to specific products they offer at specific prices. The comparison is based on criteria selected by the user, allowing the customer to specify exactly what criteria are important to him. This comparison therefore requires significant time for the user to specify his preferences. It is only well-adapted to knowledgeable consumers, and for comparing merchants who sell very similar products for which detailed pricing information is available.

It is also known to rank merchants following payment transactions made using a payment card. As used in this document, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. US 2014/279185A1 and US 2012/0296724 propose ranking merchants based on transactional data describing payment transactions made with a payment card using payment network. However, both these systems are for presenting personalized rankings, i.e. specific to a given customer who is seeking a merchant recommendation. Both rely inter alia on payment data describing the previous payment transactions made by the same potential customer to whom the merchant ranking is presented. This payment data may be generated by the payment network associated with the potential customer's payment card. Thus, these ranking schemes are not well adapted to a potential customer for whom these payment transactions are not available, such as a user who has not previously used a payment card, or who has only used a payment card associated with a payment network for which the payment data is not available.

### SUMMARY OF THE INVENTION

The present invention aims to provide methods and systems for generating a ranking of merchants meeting one or more specified criteria, and presenting the ranking to potential customers (“users”). The customers may use the ranking as part of a process for selecting a merchant, as part of a process for purchasing goods and/or services.

In general terms, the invention proposes that merchants categorized by one or more selected criteria are ranked according to an algorithm which calculates a respective score (ranking value) for each merchant as a function of (i) one or more transactional data values characterising previous commercial transactions involving the merchants, (ii) one or more rating values obtained from one of more social media sources and characterising properties of the merchants according to customer feedback, and (iii) pre-determined parameters which control the relative importance of the transactional data values and rating values in determining the scores.

The invention may be implemented in the form of a centralised computer system (e.g. a server) which presents an interface to which users may connect (e.g. over the internet). Alternatively, it may be provided as an app running on a user-owned computing device, optionally communicating with external database(s).

### BRIEF DESCRIPTION OF THE DRAWINGS

An embodiment of the invention will now be described, for the sake of example only, with reference to the following drawings, in which:

FIG. 1 compares the rankings for restaurants given by five merchant comparison websites;

FIG. 2 shows a system which is an embodiment of the method;

FIG. 3 is a flow-chart of a method performed by the embodiment of FIG. 1;

FIG. 4 shows a ranking for restaurants generated by the embodiment of FIG. 1; and

FIG. 5 is a flow-chart of a method for obtaining parameters for use in the method of FIG. 1.

### DETAILED DESCRIPTION OF THE EMBODIMENTS

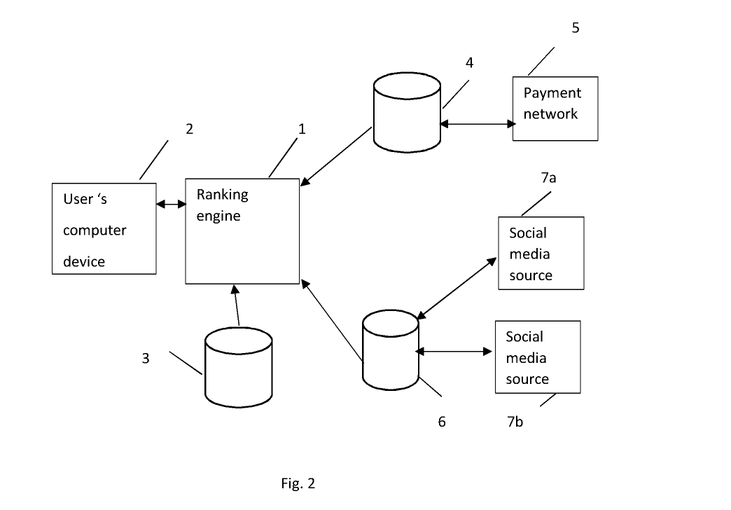

Referring to FIG. 2, an embodiment of the invention is described which is a ranking engine 1 for compiling a ranking of merchants who each supply goods and/or services (collectively referred to here as “products”), and presenting it to a user who operates a computing device 2 which is in two-way communication with the ranking engine 1. In one embodiment the ranking engine 1 is implemented as one or more servers which communicate with the computing device 2 over the internet. The computing device 2 may be a personal computer (PC) or a mobile device, such as a tablet computer or a smartphone.

The user is a potential customer for one or more goods and/or services, which are supplied by a plurality of merchants. The ranking engine 1 is able to access a database 3 of basic data describing each of these merchants: for example, describing the geographical location of the merchants and the product(s) each merchant offers.

The ranking engine 1 is able to access a transactional data database 4 storing, for each of the merchants, one or more transactional data values characterising previous commercial transactions involving the merchant. The transactional data database 4 is generated by a payment network 5. Note that the data contained in the database 4 does not include data describing individual transactions, but rather data values which each describe a plurality of transactions involving a corresponding merchant.

For example, the transactional data values may store one of more of the following values:

TABLE A

| | Transactional data | |
|---|---|---|
| | value | Explanation |
| 1 | SPEND | Total money spent at the merchant in all the |
| | | transactions involving the payment network 5 |
| 2 | TXNS | Total number of transactions involving the |
| | | payment network 5 |
| 3 | ACCOUNTS | Number of payment cards for which the pay- |
| | | ment network 5 processed transactions |
| | | involving the merchant |
| 4 | SPEND/TXNS (or | The average SPEND per transaction |
| | “ticket size”) | |
| 5 | SPEND/ACCOUNT | The average spend per payment card for which |
| | | the payment network 5 processed transactions |
| | | involving the merchant |
| 6 | TXN/ACCOUNT | The number of transactions per payment card |
| | | for which the payment network 5 processed |
| | | transactions involving the merchant; this value |
| | | is indicative of customer loyalty |

Some of the values above can be derived from one another (for example, quantity 4 is just the ratio of quantities 1 and 2), so the transactional data database 4 may either store all these values for each merchant, or it may store only a subset of them and the ranking engine 1 may calculate the other values from those which are stored.

In addition, the transaction data database 4 may store data relating to each of a plurality of product categories, and in this case, the database 4 may store “normalised” data for each of the categories, relating only to transactions involving that product category. This data is stored for each of the merchants who offer that product category. For example, if a certain merchant only offers a single product category (e.g. high end hotel rooms), the database 4 may contain transaction data value(s) which are indicated as being associated with that product category, while not storing transaction data values associated with any other product category. Alternatively, a given merchant may sell products in a plurality of product categories (e.g. a merchant which is a hotel chain may offer both “high end” rooms and “economy class”), and the database 4 contains transaction data values for each of those categories. This data is “normalised”, i.e. specific to a given product category.

For a given product category and a given merchant, the database may store normalised data of the following form:

TABLE B

| | Transactional data | |
|---|---|---|
| | value | Explanation |
| 1 | NORMALISED | Indexed SPEND which will be spend at |
| | SPEND | merchant divided my average SPEND at |
| | | the merchants within the same Industry |
| 2 | NORMALISED | Indexed transactions which will be trans- |
| | TXNS | actions at merchant divided my average |
| | | transactions at the merchants within the |
| | | same Industry |
| 3 | NORMALISED | Indexed accounts counts which will be |
| | ACCOUNTS | accounts at merchant divided my average |
| | | no of accounts at the merchants within the |
| | | same Industry |
| 4 | NORMALISED | Indexed average spend per transaction for |
| | SPEND/TXNS (or | the given merchant |
| | “ticket size”) | |
| 5 | NORMALISED | Indexed spend per account for the given |
| | SPEND/ACCOUNT | merchant |
| 6 | NORMALISED | Indexed transaction per account for the |
| | TXN/ACCOUNT | given merchant |

Optionally, the product categories may be defined by multiple criteria. For example, within the broad category of “restaurants”, a first criterion may be whether the restaurant is “high end” or “low end”. A second criterion may be the type of food sold (e.g. Italian or Indian). One possible category may be defined as “high end Italian food”.

The ranking engine is further able to access a reputation database 6 which stores rating values which are generated from data obtained from one or more merchant comparison organisations 7a, 7b (typically, websites) which collect customer feedback in respect of the merchants. That is, they are social media sources. In FIG. 2, two such merchant comparison organisations 7a, 7b are shown, but there may be any number of such organisations. The database 6 is typically structured so that it includes for each merchant of a given type, one or more rating values describing how good the merchants are for each of one or more respective predetermined criteria. Each of these rating values is obtained by averaging corresponding data from the organisations 7a, 7b. For example, in the case of merchant which are restaurants, the organisations 7a, 7b would each supply, for each restaurant, rating values indicating how prior users of the restaurants scored them for food quality, service quality, value for money and ambience. The database 6 stores four rating values which are averages of the respective rating values supplied by the organisations 7a, 7b. In contrast to the objective transaction data values stored in the database 4, the rating values in database 6 are subjective.

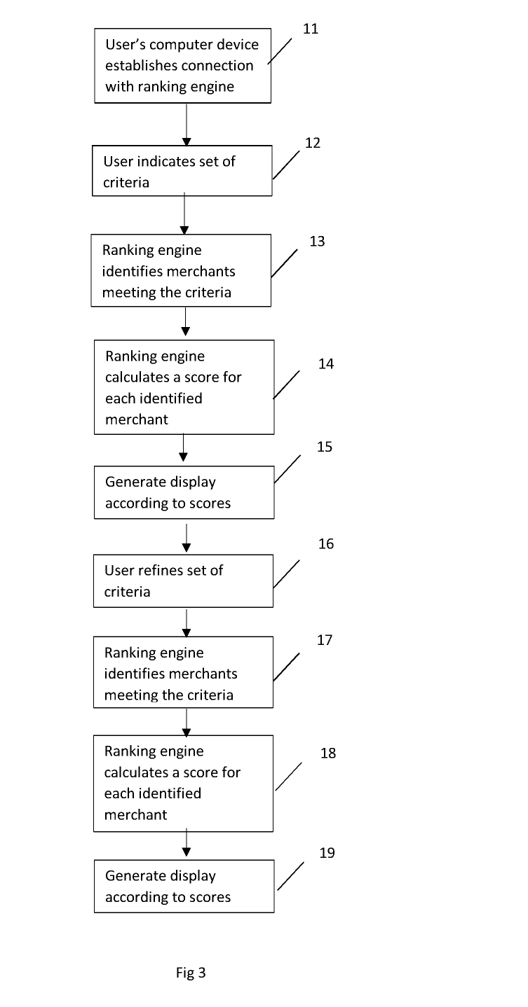

FIG. 3 illustrates a method for using the system of FIG. 2. Upon the user using the computing device 2 to access the ranking engine 1 (step 11), for example over the Internet using a browser, the user indicates a set of criteria indicating a product which the user wishes to purchase (step 12). The ranking engine uses the database 3 to identify the merchants offering this product (step 13). It then generates a score for each of the identified merchants (step 14), and uses the scores to generate data which is sent to the computing device 2 to cause it to display to the user of a list of the identified merchants (or at any rate, one or more of the identified merchants having the highest score) (step 15). For example, the identified merchants (or a subset of them having the highest scores) may be listed in an order depending on the score (e.g. from highest to lowest score); and/or the identified merchants (or a subset of them having the highest scores) may be listed together with the score displayed.

Subsequently, the user may specify the desired product category in more detail (step 16). In this case, the ranking engine identifies the merchants selling this product category using the database 3 (step 17), and calculates scores for them, this time using the normalised values for the selected product category (step 18), and displays the results (step 19). Note that the order of a given pair of merchants may be different in the ranking presented in step 15 from that presented in step 19, for example in the case that the transactional data values indicate that the one of the pair of merchants has a greater specialisation in the products of the selected category.

The score for each merchant is computed at steps 14 and 18 according to a predefined equation, which is a function of data in the databases 4, 6 relating to that merchant. Specifically, the function is a function (e.g. a sum) of at least some of the data in the databases 4 and 6 relating to that merchant, weighted by pre-determined weighting parameters. In step 14, it is a weighted sum of the values for Table A in the database 4, and the rating values in the database 6. Whereas, in step 18 the score may be calculated for example as a weighted sum of the normalised quantities in table B relating to that product category, and the rating values in the database 6.

For example, in the case of restaurants, the score for a certain product category may be calculated, according to a score model which is a function in the form:

Score=0.75Sₒ+0.3Sₛ

where Sₒ is a function (“objective score”) which is a weighted sum of some of the objective transaction data values (i.e. transactional level data variables derived from database 4) and which is given an overall weight of 0.7, while Sₛ is a function (“subjective score”) which is a weighted sum of the subjective values from the database 6 and which is given an overall weight of 0.3.

In step 14, before the user has specified a product category, the merchants are ranked using a score in which the Sₒ is based on three variables i.e. spend, number of accounts and spend per account with weightage of 0.33, 0.33, 0.33.

In step 18, each product category has a different function Sₒ, i.e. Sₒ for each product category is defined by a different respective set of weight parameters, and these weight parameters weight the respective values of respective parameters of Table B for that product category. The method of calculating the weights of a given product category is given below. In one specific example the score for a certain product category may be defined as:

Score=0.7×(0.04240+0.9385*Normalized Spend+0.04191*Normalized Txn+0.9743*Normalized Account−0.0148*Normalized Spend/Txn+0.7482*Normalized Txn/Account+1.053*Normalized Spend/Account)+0.3×(0.25*Food quality rating+0.25*Service quality rating+0.25*Value for money rating+0.25*Ambience of restaurant rating). (1)

Alternatively, according to a second possible model, the score may be calculated as:

Score=0.7×(0.9300*Normalized Spend+0.02549*Normalized Txn+0.9876*Normalized Account+0.02316*Normalized Spend/Txn+0.9760*Normalized t×n/account+0.9521*Normalized Spend/account)+0.3×(0.25*Food quality rating+0.25*Service quality rating+0.25*Value for money rating+0.25*Ambience of restaurant rating). (2)

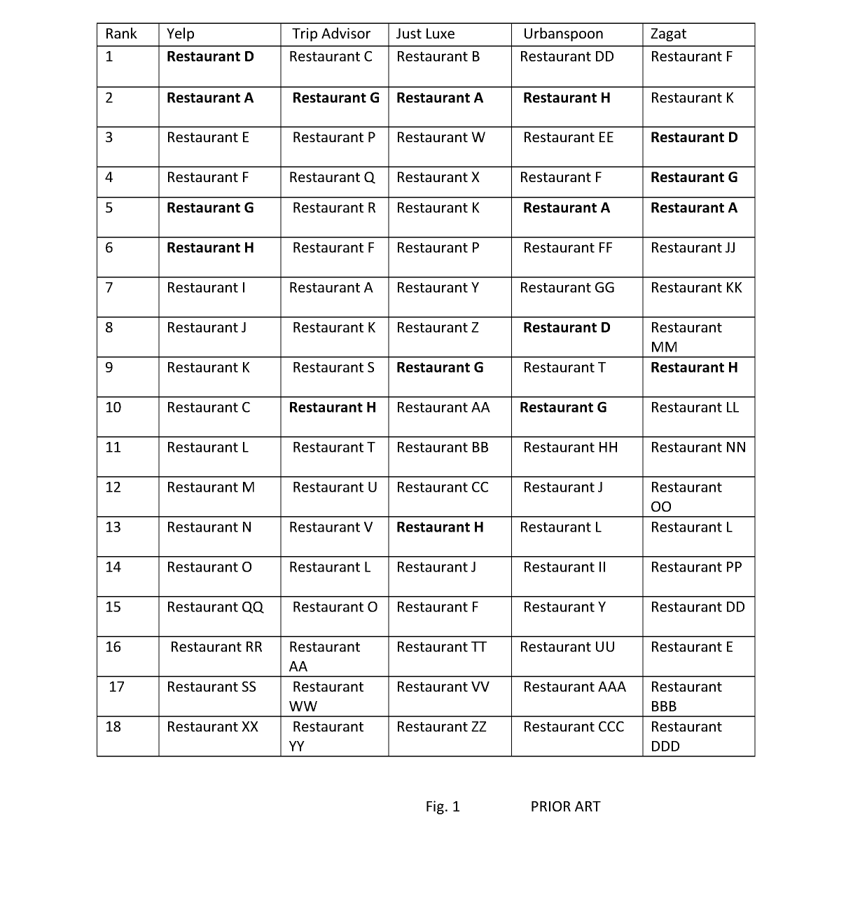

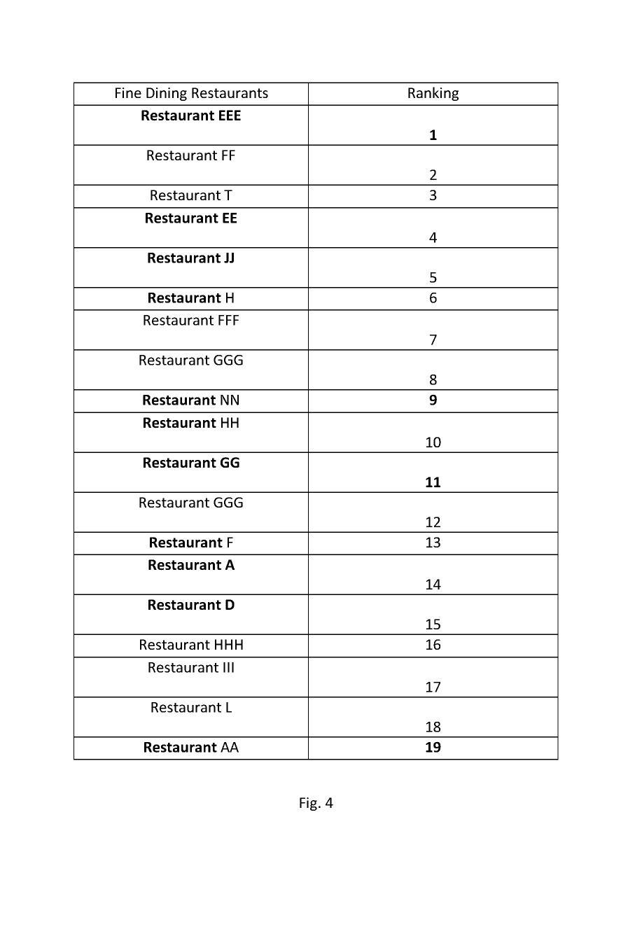

The ranking for restaurants in the city produced using Eqn. (2) in an experiment was as shown in FIG. 4. The top ranking restaurant (referred to in FIG. 4 as “Restaurant EEE”) is not in any of the rankings shown in FIG. 1, probably because not enough reviews have been received, and neither are four further restaurants which 4 calls “Restaurants FFF” to “Restaurant III”.

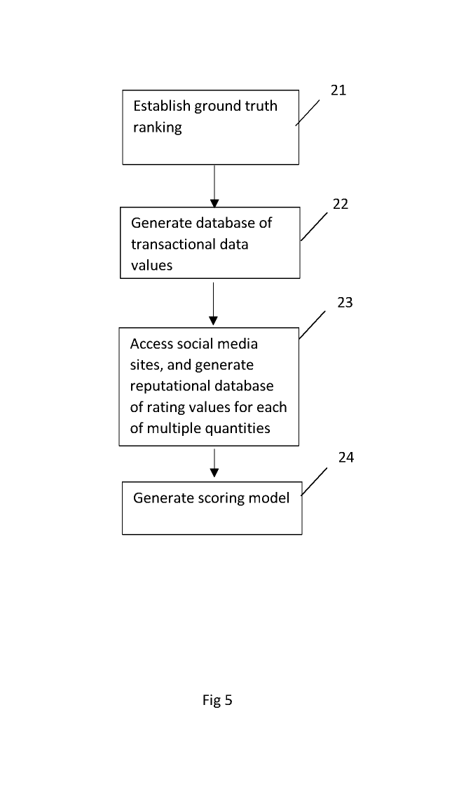

The process for generating the scoring model (e.g. Eqn. (1) or Eqn. (2) for a given product category is shown in FIG. 5. Note that the method may be performed for a certain a class of the merchants (e.g. the merchants who provide one of the product categories, in one of geographical region), and then the same numerical values used in scoring other similar classes of the merchant. For example, it can be performed in respect of Italian food restaurants in New York, and then the same parameters used to classify food restaurants for other types of food and/or other geographical locations.

In step 21, an initial ranking of a certain number of the top merchants (this set is referred to as the “trial merchants”; in variations of the embodiment the trial merchants need not be the top merchants) is calculated based on three variables i.e. spend, number of accounts and spend per account with weightage of 0.33, 0.33, 0.33. These are three of the parameters of Table A. Each of the top merchants is thus given a preliminary score. This is a preliminary score for each of the top merchants. The preliminary score is taken as the base for calculating the weightings given to the objective transaction level data/variables.

In step 22, all the variables as specified in tables A and B for each merchant (not just the trial merchants) are calculated, and for each product category the corresponding set of weights for the objective score Sₒ are calculated. Sₒ for a given product category is calculated as a function of a plurality of the parameters shown in Table B for that product category. The respective weighting parameters for each of the parameters in Table B are calculated such that the weighted sums Sₒ for the top merchants are as close as possible to the preliminary scores calculated above (which as explained were calculated using the values of three parameters of Table A). This calculation is performed by an iterative linear regression process, termed regression model development.

In step 23, subjective information from social media websites 7a, 7b is collected for each of multiple variables, for each of the variables a numerical rating value is derived from the collected information, the rating values are combined into a single subjective score (“Sₛ”) and stored in the reputational database 6. For example, in the case of restaurants, all the social media websites give scores for each merchant for each of four variables: service quality, value for money, ambience and food quality. For each of these variables, a corresponding rating value may be calculated by combining the corresponding values on the social media websites. A combination of these rating values gives the subjective score Sₛ. For example, equal weights are given to each of these rating values in Eqns. (1) and (2), i.e. each is given a relative weight of 0.25.

Note that in a different embodiment, the relative weights of each of the rating values in Eqns. (1) and (2) may be given different values (e.g. if value for money and/or food quality are demonstrated (for example by surveys of diners) to be more important to diners than service or ambience, their corresponding relative weight(s) may be higher). Nor is it essential that the rating values are combined linearly to form the subjective score (that is, as a weighted sum); for example, if food quality is found to be very low then the subjective score Sₛ may be restricted to a low value, irrespective of how high the other scores are.

Furthermore, the data values from different social media sites might not be on the same scale. For example, one social media site might have a scale for a certain variable which is an integer in the range 1 to 10, while another social media site might rate the variable as an integer in the range 1 to 5 (i.e. from 1 to 5 stars), while a third social media site might for example use school grades A . . . F. Thus, a pure numerical average might be misleading. Instead, more generally, for each of the variables, the respective data values from the social media websites are combined as appropriate, for example by converting each to a common scale, and then generating the rating values as a numerical combination of the converted scores (e.g. a weighted mean, or another average such as a median).

In step 24, Eqns. (1) and (2) are created with the objective score Sₒ of the weightings for the objective transaction data values (i.e. transactional level data variables derived from database 4) given an overall weight of 0.7, while the subjective score Sₛ from the subjective information (i.e. the rating values from database 6) is given an overall weight of 0.3. Again, in another embodiment the relative weighting of Sₒ and Sₛ may be different. Combining the transaction data values and the weighed subjective information gives the final model equations, e.g. Eqn. (1) and (2). Note that the regression model development process is iterative, and depends in detail on which variables are used, so a different realization of the process would yield different coefficients (e.g. for a different product category, or if there is a different number of iterative steps and/or if the objective transaction data values used are different from those in Tables A and B, or if the variables are transformed in some way).

The embodiment has several advantages. Firstly, it is not reliant on any data describing the user (potential customer). Thus, it can be used by a customer who gives very little information about his personal criteria for choosing a merchant, and/or by a customer for whom no payment card transaction data is available. Second, it is relatively insensitive to any problems in the subjective data from the social media websites (e.g. fake reviews).

The embodiment may be conveniently implemented by a bank or other party who is involved in payment transactions, and who thus has access to the transaction data used to create the database 4.

Although only a single embodiment of the invention has been described in detail, many variations are possible. For example, additional information may be incorporated into the calculation of the scores, such as any available data describing the balance sheet of the merchants.

As noted above, the ranking engine 1 may be implemented as one or more servers which communicate with a separate computing device 2 over the internet. In this case, the ranking engine comprises an interface for receiving data from the computing device 2 indicating the criteria which the merchants must meet and indicative of the products the user wants to purchase, and for transmitting data to the computing device 2, for example in the form of data indicating how a display is to be generated, which shows the merchants identified as meeting the criteria, in a form according to the ranking. However, the ranking engine may alternatively include a component which is an application stored and running on the computing device 2. Indeed, in certain embodiments the ranking engine may be entirely implemented as such an application. Furthermore, although the databases 3, 4, 6 are illustrated as being separate, any one or more of them may be portions of a single larger database.

1. A computer system for generating a ranking of merchants, comprising:
a first database storing information describing a plurality of merchants;
a transactional data database storing one or more transactional data values characterising previous payment card transactions involving the merchants,
a reputation database storing one or more rating values derived from one or more social media sources and characterising properties of the merchants according to customer feedback, and
a ranking engine which is operative to
(i) identify a plurality of the merchants meeting one or more specified criteria,
(ii) for each of the identified merchants calculating a score which is a function of at least some of the corresponding transactional data values and the corresponding rating values, weighted by pre-determined weighting parameters which control the relative importance of the transactional data values and the rating values in determining the scores; and
(iii) generate display data for causing the display of the names of at least a subset of the identified merchants, the display being according to the respective calculated scores.

2. A computerized method of generating and displaying a ranking of merchants, comprising:
(i) receiving input from a user specifying one or more criteria;
(ii) using a first database storing information describing a plurality of merchants to identify which of the merchants meet the criteria;
(iii) for each of the identified merchants, generating a respective score using a score function for each merchant which is a function of:
(a) one or more respective transactional data values stored in a transactional data database and characterising previous payment card transactions involving the merchant,
(b) one or more respective rating values derived from one of more social media sources, the rating values characterising respective properties of the merchant according to customer feedback, and
(c) pre-determined weighting parameters which control the relative importance of the transactional data values and rating values in determining the score; and
(iv) causing a display to the user of at least a subset of the identified merchants, the display being according to the respective calculated score.

3. A method according to claim 2 further including receiving the transactional data values from a payment network.

4. A method according to claim 2 in which there is a plurality of said social media sources, the method further including generating the one or more rating values for each merchant by:
obtaining from each of the social media sources one or more data values characterizing one of more respective qualities of the merchant; and
generating each rating value as a combination of the data values for a respective one of the qualities.

5. A method according to claim 2 in which the scores are weighted sums of the transactional data values and the rating values, with a weighting depending on the weighting parameters.

6. A method according to claim 2 in which the transactional data values for each merchant comprise at least one of the group of following quantities:
(a) a total value of the payment card transactions involving the merchant;
(b) a total number of payment card transitions involving the merchant;
(c) a number of payment cards for which there has been a transaction involving the merchant;
(d) the ratio of quantities (a) and (b);
(e) the ratio of quantities (a) and (c); and
(f) the ratio of quantities (b) and (c).

7. A method according to claim 2 further comprising:
(v) receiving additional user input specifying additional criteria;
(vi) extracting from the transactional data database data describing previous transactions by the merchant satisfying the additional criteria;
(vii) for at least some of the merchants generating a respective refined score using a revised score function which is a function of:
(a) one or more respective normalized transactional data values stored in a transactional data database and characterising previous commercial transactions involving the merchant and satisfying the criteria;
(b) the one or more respective rating values, and
(c) pre-determined weighting parameters; and
(viii) causing a display to the user of at least a subset of the identified merchants, the display being according to the respective refined score.

8. A method according to claim 7 in which the normalized transactional data values for each merchant comprise at least one of the group of following quantities:
(a) a total value of the payment card transactions involving the merchant for a product category;
(b) a total number of payment card transitions involving the merchant for the product category;
(c) a number of payment cards for which there has been a transaction involving the merchant for the product category;
(d) the ratio of quantities (a) and (b);
(e) the ratio of quantities (a) and (c); and
(f) the ratio of quantities (b) and (c).

9. A method of generating a score function, the score function being for ascribing a score to a merchant, the method including:
(i) for each of a set of trial merchants, defining a respective preliminary score based on a first set of transactional data values for the corresponding merchant;
(ii) deriving respective weighting parameters for each of a second set of transactional data values, the weighting parameters being selected to give, for each of the trial merchants, a respective weighted sum of the second set of transactional data values for the corresponding trial merchant which approximates the corresponding preliminary score; and
(iii) generating the score function for the merchant as a function of:
(a) the set of weighting parameters and the corresponding second set of transactional data values for the merchant; and
(b) one or more respective rating values derived from one of more social media sources, the rating values characterising respective properties of the merchant according to customer feedback.

10. A method according to claim 8 in which the step of obtaining weighting parameters is performed by a linear regression process.

11. A method according to claim 7, in which in step (ii) the respective score for each merchant is calculated using a refined score function.

12. A method according to claim 7, in which the refined score function includes ascribing a score to a merchant, the method further including:
(i) for each of a set of trial merchants, defining a respective preliminary score based on a first set of transactional data values for the corresponding merchant;
(ii) deriving respective weighting parameters for each of a second set of transactional data values, the weighting parameters being selected to give, for each of the trial merchants, a respective weighted sum of the second set of transactional data values for the corresponding trial merchant which approximates the corresponding preliminary score; and
(iii) generating the score function for the merchant as a function of:
(a) the set of weighting parameters and the corresponding second set of transactional data values for the merchant; and
(b) one or more respective rating values derived from one of more social media sources, the rating values characterising respective properties of the merchant according to customer feedback.

13. A non-transitory computer-readable medium having stored thereon program instructions for causing at least one processor to perform a method, comprising:
(i) receiving input from a user specifying one or more criteria;
(ii) using a first database storing information describing a plurality of merchants to identify which of the merchants meet the criteria;
(iii) for each of the identified merchants, generating a respective score using a score function for each merchant which is a function of:
(a) one or more respective transactional data values stored in a transactional data database and characterising previous payment card transactions involving the merchant,
(b) one or more respective rating values derived from one of more social media sources, the rating values characterising respective properties of the merchant according to customer feedback, and
(c) pre-determined weighting parameters which control the relative importance of the transactional data values and rating values in determining the score; and
(iv) causing a display to the user of at least a subset of the identified merchants, the display being according to the respective calculated score.
